(19) United States
(12) Patent Application Publication
(10) Pub. No.: US 2005/0063543 A1
(43) Pub. Date: Mar. 24, 2005

(54) Hardware acceleration for Diffie Hellman in a device that integrates wired and wireless L2 and L3 switching functionality

(76) Inventors: Mathew Kayalackakom, Cupertino, CA (US); Abhijit K. Choudhury, Cupertino, CA (US); Ken C. K. Chin, Saratoga, CA (US); Shekhar Ambe, San Jose, CA (US)

Correspondence Address: Pillsbury Winthrop LLP;Intellectual Property Group, Suite 200, 11682 El Camino Real, San Diego, CA, 92130-2092, US

(21) Appl. No.: 10/884,810

(22) Filed: Jul. 2, 2004

Related U.S. Application Data
(60) Provisional application No. 60/484,819, filed on Jul. 3, 2003.

(51) Int. Cl. H04K 1/00

(52) U.S. Cl. 380/270

(57) ABSTRACT

An apparatus provides an integrated single chip solution to solve a multitude of WLAN problems, and especially Switching/Bridging, and Security. In accordance with an aspect of the invention, the apparatus is able to terminate secured tunneled IPSec, L2TP with IPSec, PPTP, SSL traffic. In accordance with a further aspect of the invention, the apparatus is also able to handle computation-intensive security-based algorithms such as Diffie Hellman without significant reduction in traffic throughput. The architecture is such that it not only resolves the problems pertinent to WLAN it is also scalable and useful for building a number of useful networking products that fulfill enterprise security and all possible combinations of wired and wireless networking needs.

### CROSS-REFERENCE TO RELATED APPLICATIONS

The present application claims priority to provisional application 60/484,819, filed on Jul. 3, 2003.

### FIELD OF THE INVENTION

Aspects of the present invention relate generally to network communications, and more particularly, to wired and wireless networks and architectures.

### BACKGROUND OF THE INVENTION

The Wireless Local Area Network (WLAN) market has recently experienced rapid growth, primarily driven by consumer demand for home networking. The next phase of the growth will likely come from the commercial segment, such as enterprises, service provider networks in public places (Hotspots), multi-tenant, multi-dwelling units (MxUs) and small office home office (SOHOs). The worldwide market for the commercial segment is expected to grow from 5M units in 2001 to over 33M units in 2006. However, this growth can be realized only if the issues of security, service quality and user experience are addressed effectively in newer products.

FIG. 1 illustrates possible wireless network topologies. As shown in FIG. 1, a wireless network 100 typically includes at least one access point 102, to which wireless-capable devices such as desktop computers, laptop computers, PDAs, cellphones, etc. can connect via wireless protocols such as 802.11a/b/g. Several or more access points 102 can be further connected to an access point controller 104. Switch 106 can be connected to multiple access points 102, access point controllers 104, or other wired and/or wireless network elements such as switches, bridges, computers, and servers. Switch 106 can further provide an uplink to another network. Many possible alternative topologies are possible, and this figure is intended to illuminate, rather than limit, the present inventions.

Problems with security, in particular, are relevant to all possible deployments of wireless networks. Most of the security problems have been brought on by flaws in the WEP algorithm which seriously undermine the security of the system making it unacceptable as an Enterprise solution. In particular, current wireless networks are vulnerable to:
Passive attacks to decrypt traffic based on statistical analysis.
Active attack to inject new traffic from unauthorized mobile stations, based on known plaintext.
Active attacks to decrypt traffic, based on tricking the access point.
Dictionary-building attacks that, after analysis of about a day's worth of traffic, allows real-time automated decryption of all traffic.

Analysis suggests that all of these attacks can be mounted using only inexpensive off-the-shelf equipment. Anyone using an 802.11 wireless network should not therefore rely on WEP for security, and employ other security measures to protect their wireless network. In addition WLAN also has security problems that are not WEP related, such as:
Easy Access—“War drivers” have used high-gain antennas and software to log the appearance of Beacon frames and associate them with a geographic location using GPS. Short of moving into heavily shielded office space that does not allow RF signals to escape, there is no solution for this problem.
“Rogue” Access Points—Easy access to wireless LANs is coupled with easy deployment. When combined, these two characteristics can cause headaches for network administrators. Any user can run to a nearby computer store, purchase an access point, and connect it to the corporate network without authorization an thus be able to roll out their own wireless LANs without authorization.
Unauthorized Use of Service—For corporate users extending wired networks, access to wireless networks must be as tightly controlled as for the existing wired network. Strong authentication is a must before access is granted to the network.
Service and Performance Constraints—Wireless LANs have limited transmission capacity. Networks based on 802.11b have a bit rate of 11 Mbps, and networks based on the newer 802.11 a technology have bit rates up to 54 Mbps. This capacity is shared between all the users associated with an access point. Due to MAC-layer overhead, the actual effective throughput tops out at roughly half of the nominal bit rate. It is not hard to imagine how local area applications might overwhelm such limited capacity, or how an attacker might launch a denial of service attack on the limited resources.
MAC Spoofing and Session Hijacking—802.11 networks do not authenticate frames. Every frame has a source address, but there is no guarantee that the station sending the frame actually put the frame “in the air.” Just as on traditional Ethernet networks, there is no protection against forgery of frame source addresses. Attackers can use spoofed frames to redirect traffic and corrupt ARP tables. At a much simpler level, attackers can observe the MAC addresses of stations in use on the network and adopt those addresses for malicious transmissions.
Traffic Analysis and Eavesdropping—802.11 provides no protection against attackers that passively observe traffic. The main risk is that 802.11 does not secure data in transit to prevent eavesdropping. Frame headers are always “in the clear” and are visible to anybody with a wireless network analyzer.

There are no enterprise-class wireless network management systems that can address all of these problems. Attempts have been made to address certain of these problems, usually on a software level.

Meanwhile, however, many WLAN vendors are integrating combined 802.11 a/g/b standards into their chipsets. Such chipsets are targeted for what are called Combo-Access Points which will allow users associated with the Access Points to share 100 Mbits of bandwidth in Normal Mode and up to ˜300 Mbits in Turbo Mode. The table below shows why a software security solution without hardware acceleration is not feasible when bandwidth/speeds exceed 100 Mbits.

| | | Required | | |
|---|---|---|---|---|
| | | Processor Speed | | |
| Interface | | [MHz] | | CPU |
| | BW | | IPSec + | Subsys |
| Type | [Mbs] | IPSec | Other | Cost |
| DSL | 1-5 | 133 | 200+ | |
| Ether | 10 | 300 | 500+ | |
| 802.11a | 30-50 | 1200 | 1500+ | $400 |
| | | | | [2002] |
| | | | | $125 |
| | | | | [2004] |
| Fast | 100 | 2500 | 3000+ | $600 |
| Ether | | | | [2002] |
| | | | | $250 |
| | | | | [2004] |

| | | |
|---|---|---|
| Multiple | 500 | Not Feasible in Software |
| FE | | Needs Dedicated Hardware |
| Gigabit | 1000 | |
| Ether | | |

Current solutions also provide only limited support for switching of IPSec and L2TP with IPSec traffic. Moreover, IPSec and other secure protocols can involve very complex and computation-intensive algorithms such as Diffie Hellman that can substantially reduce traffic throughput if not handled efficiently.

Although infrastructures for wired networks have been highly developed, the above and other problems of wireless networks are comparatively less addressed. Meanwhile, there is a need to address situations where enterprises and/or networks may have any combination of both wired and wireless components.

### SUMMARY

The embodiments of the present invention relate generally to a single-chip solution that addresses current weaknesses in wireless networks, but yet is scalable for a multitude of possible wired and/or wireless implementations. Current solutions to resolve/overcome the weaknesses of WLAN are only available in the form of Software or System implementations. These resolve only specific WLAN problems and they do not address all of the existing limitations of wireless networks.

In accordance with an aspect of the invention, an apparatus may provide an integrated single chip solution to solve a multitude of WLAN problems, and especially Switching/Bridging, and Security. In accordance with an aspect of the invention, the apparatus is able to terminate secured tunneled IPSec and L2TP with IPSec traffic. In accordance with a further aspect of the invention, the apparatus is also able to handle computation-intensive security-based algorithms such as Diffie Hellman without significant reduction in traffic throughput. The architecture is such that it not only resolves the problems pertinent to WLAN it is also scalable and useful for building a number of useful networking products that fulfill enterprise security and all possible combinations of wired and wireless networking needs.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates wireless network topologies;

FIG. 2 is a block diagram illustrating a wired and wireless network device architecture in accordance with an embodiment of the present invention;

FIG. 3 is a block diagram illustrating a crypto engine embodiment with hardware support for Diffie Hellman in accordance with an aspect of the present invention; and

FIG. 4 is a block diagram illustrating an example implementation of traffic processing including Diffie Hellman in accordance with an embodiment of the present invention.

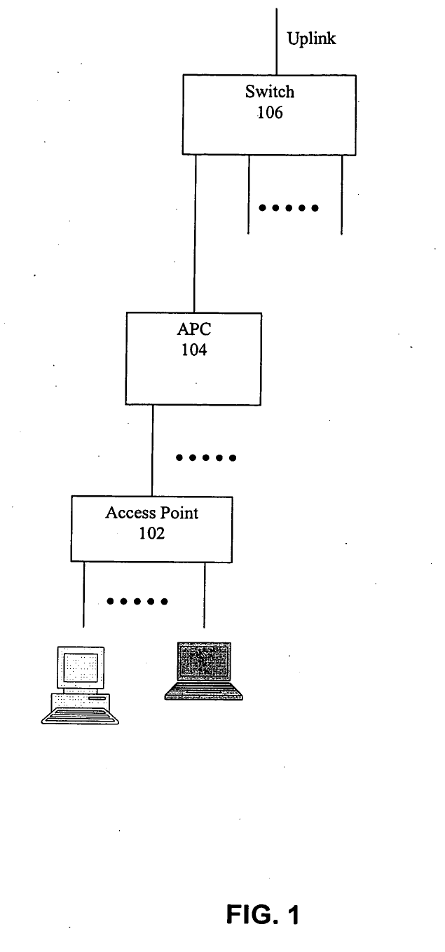

### DETAILED DESCRIPTION

One aspect of the present invention is the discovery that it would be desirable to deliver a single chip solution to solve wired and wireless LAN Security, including the ability to terminate a secure tunnel in accordance with such protocols as IPSec and L2TP with IPSec, including the efficiently ability to handle complex computational functions such as Diffie Hellman without a reduction in throughput. Such a single chip solution should also be scalable to enable implementation in the various components and alternative topologies of wired and/or wireless networks, such as, for example, in an access point, an access point controller, or in a switch.

The embodiments of the present invention will now be described in detail with reference to the drawings, which are provided as illustrative examples of the invention so as to enable those skilled in the art to practice the invention. Notably, the figures and examples below are not meant to limit the scope of the present invention. Moreover, where certain elements of the embodiments can be partially or fully implemented using known components, only those portions of such known components that are necessary for an understanding of embodiments will be described, and detailed descriptions of other portions of such known components will be omitted so as not to obscure the invention. Still further, aspects of the present invention encompass present and future known equivalents to the known components referred to herein by way of illustration, and implementations including such equivalents are to be considered alternative embodiments of the invention.

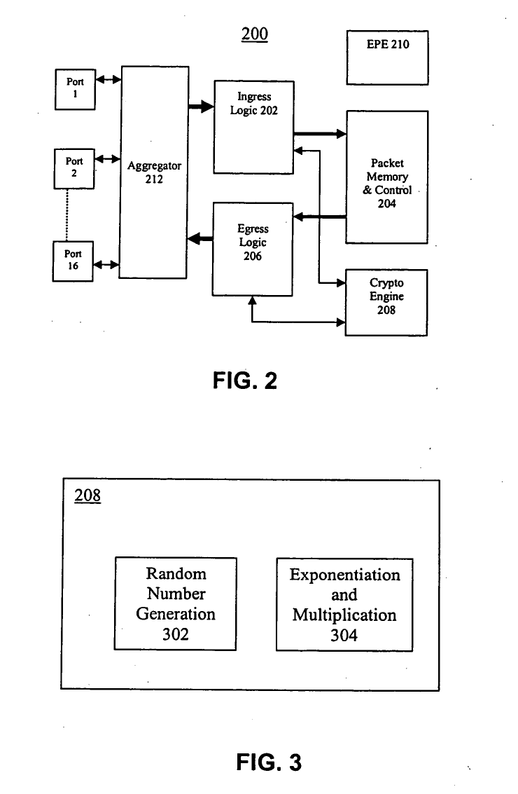

FIG. 2 is a block diagram illustrating an example implementation of a single-chip wired and wireless network device 200 that can be used to implement the features of the present invention. As shown in FIG. 2, chip 200 includes ingress logic 202, packet memory and control 204, egress logic 206, crypto engine 208, an embedded processor engine 210 and an aggregator 212. One example device 200 is described in detail in co-pending application No. ______ (Atty. Dkt. 79202-309844 (SNT-001)), the contents of which are incorporated herein by reference.

In accordance with one aspect of the invention, IPSec packets received and destined for the chip 200 are forwarded to the Crypto Engine 208 for authentication and decryption. Normally a VPN Session between WLAN Client and Access Point/Switch uses the IPSec tunnel mode (transport mode can be used for network management). The Pre-parsing is done by the Ingress logic to determine the type of packet, whether it is IKE, IPSec, L2TP or PPTP.

As described in more detail in co-pending application Ser. No. ______ (Atty. Dkt. 79202-309852 (SNT-003)), incorporated herein by reference, the Crypto Engine is able to provide hardware acceleration for IKE VPN authentication, encryption and decryption for packets destined to and tunneled packets from a WLAN network. Of the standards for authentication, encryption and decryption device 200 will support those for SSL, TLS, IPSec, PPTP with MPPE and L2TP with IPSec. All packets originating from and destined to WLAN clients are tunneled using IPSec VPN, L2TP, PPTP or SSL. The authentication, encryption and decryption method used for tunneling is configurable and negotiated between a device 200-based peer and the WLAN client. As per tunneling standards a single policy or a policy bundle may govern packet authentication, encryption/decryption.

In accordance with an aspect of the present invention, crypto engine 208 further includes hardware acceleration of algorithms such as Diffie Hellman. Diffie Hellman for IPSec based VPN involves generation of large prime numbers with good random properties, their exchange and very intensive mathematical operations involving exponentiation and multiplication. Network switches that provide similar support must therefore accelerate the random number generation and mathematical operations using some form of hardware acceleration in order to satisfy overall throughput expectations. Hardware Acceleration for Diffie Hellman requires both Random Number Generation and Exponentiation and Multiplication, as illustrated in FIG. 3.

Random Number Generation

Random numbers are basic building blocks for cryptography, which in turn is the foundation of security technology. Seeds created from true random numbers generate stronger encryption keys for IKE/IPSec. The best random number generators (RNG) produce statistically random and non-deterministic numbers. Only hardware RNG meets both these requirements. Software-based pseudo RNGs do not generate numbers that are completely random and non-deterministic. This lack of randomness provides a security hole for hackers to exploit. Software pseudo RNGs attempt to get around this by generating “seeds” from a number of sources in the system. However, the fact that these seed sources are not random means the system is still more vulnerable to attack than a random source. Hardware RNG significantly improves the process of generating random numbers in the system by providing a faster and truly random seed source.

Exponentiation and Multiplication for Diffie Hellman

Diffie-Hellman key exchange and RSA public-key encryption both rely on functions like this:
(g\hat{ }a)mod p
(\hat{ } denotes raising-exponentiation to a power, and % denotes modulus, the remainder after dividing).
Where
1. g has to be primitive modulo p.
2. a has to be a large number (768, 1024 bits, or Group 5 1536 bits) such that (a−1)/2 is also prime.
3. g doesn't necessarily have to be primitive modulo a, but if g is not primitive, p has to be larger so that g generates just as big a subgroup.

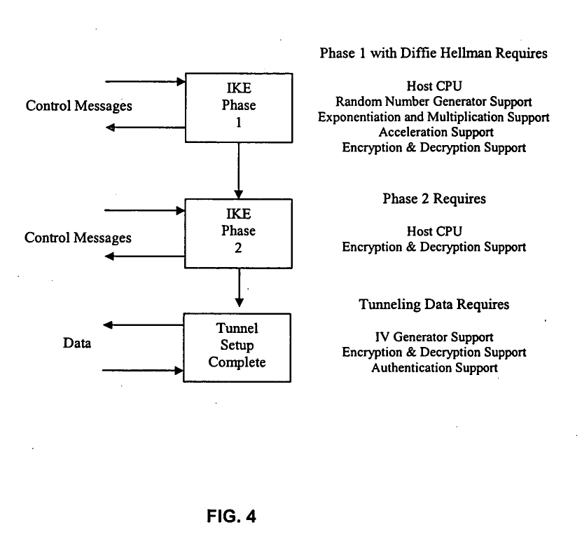

An example of how hardware support for Diffie Hellman is integrated in three phases of secured tunneled traffic handling is illustrated in FIG. 4.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims include such changes and modifications.

1. An apparatus of sending an outbound packet originated by a wireless client to a wired network via an access point, comprising:
a random number generator configured to generate an encryption key;
a mathematical accelerator configured to calculate exponentiation and modulii;
an encryptor configured to authenticate the wireless client, configured to associate the wireless client with the access point, configured to determine if the outbound packet requires security processing, and configured to process the outbound packet when the outbound packet requires security processing.

2. The apparatus of claim 1, the encryptor further configured to use the encryption key generated by the random number generator.

3. The apparatus of claim 2, wherein the encryption key is a Diffie-Hellman key exchange.

4. The apparatus of claim 3, wherein the security processing is Internet Key Exchange (IKE), Virtual Private Network, Internet Protocol Security (IPSec), Layer Two Tunneling Protocol (L2TP), Secure Sockets Layer (SSL) or Point-to-Point Tunneling Protocol (PPTP) packet processing.

5. The apparatus of claim 4, wherein the encryptor is further configured to look up a Security Association (SA) in an Incoming Security Association table to authenticate or encrypt the outbound packet.

6. The apparatus of 5, wherein the Incoming Security Association table includes a lookup key comprising the Internet Protocol Security in an authentication header.

7. The apparatus of 6, wherein the encryptor is further configured to drop the outbound packet if the look up fails.

8. The apparatus of 7, wherein the encryptor is further configured to log the dropped outbound packet if the lookup fails.

9. The apparatus of 8, wherein the encryptor is further configured to authenticate data within the outbound packet if the look up succeeds.

10. The apparatus of 9, wherein the encryptor is further configured to encrypt data within the outbound packet if the look up succeeds.

11. A method of sending an outbound packet originated by a wireless client to a wired network via an access point, comprising:
authenticating the wireless client;
associating the wireless client with the access point;
determining if the outbound packet requires security processing;
processing the outbound packet using a generated encryption key when the outbound packet requires security processing.

12. The method of claim 11, wherein the encryption key is a Diffie-Hellman key exchange.

13. The method of claim 12, wherein the security processing is Internet Key Exchange (IKE), Virtual Private Network, Internet Protocol Security (IPSec), Layer Two Tunneling Protocol (L2TP), Secure Sockets Layer (SSL) or Point-to-Point Tunneling Protocol (PPTP) packet processing.

14. The method of claim 13, the processing of the outbound packet further comprising:
looking up a Security Association (SA) in an Incoming Security Association table to authenticate or encrypt the outbound packet.

15. The method of 14, wherein the Incoming Security Association table includes a lookup key comprising the Internet Protocol Security in an authentication header.

16. The method of 15, further comprising:
dropping the outbound packet if the look up fails.

17. The method of 16, further comprising:
logging the dropped outbound packet if the lookup fails.

18. The method of 17, further comprising:
authenticating data within the outbound packet if the look up succeeds.

19. The method of 18, further comprising:
encrypting data within the outbound packet if the look up succeeds.

20. A computer-readable medium, encoded with data and instructions of sending an outbound packet originated by a wireless client to a wired network via an access point, when read by a computer causes the computer to:
authenticate the wireless client;
associate the wireless client with the access point;
determine if the outbound packet requires security processing;
process the outbound packet using an encryption key when the outbound packet requires security processing.

21. The computer-readable medium of claim 20, wherein the encryption key is a Diffie-Hellman key exchange.

22. The computer-readable medium of claim 20, wherein the security processing is Internet Key Exchange (IKE), Virtual Private Network, Internet Protocol Security (IPSec), Layer Two Tunneling Protocol (L2TP), Secure Sockets Layer (SSL) or Point-to-Point Tunneling Protocol (PPTP) packet processing.

23. The computer-readable medium of claim 22, the processing of the outbound packet further comprising:
looking up a Security Association (SA) in an Incoming Security Association table to authenticate or encrypt the outbound packet.

24. The computer-readable medium of 23, wherein the Incoming Security Association table includes a lookup key comprising the Internet Protocol Security in an authentication header.

25. The computer-readable medium of 24, further encoded with instructions comprising:
dropping the outbound packet if the look up fails.

26. The computer-readable medium of 25, further encoded with instructions comprising:
logging the dropped outbound packet if the lookup fails.

27. The computer-readable medium of 26, further encoded with instructions comprising:
authenticating data within the outbound packet if the look up succeeds.

28. The computer-readable medium of 27, further encoded with instructions comprising:
encrypting data within the outbound packet if the look up succeeds.

29. An apparatus of sending an outbound packet originated by a wireless client to a wired network via an access point, comprising:
means for authenticating the wireless client;
means for associating the wireless client with the access point;
means for determining if the outbound packet requires security processing;
means for processing the outbound packet using an encryption key when the outbound packet requires security processing.

30. The apparatus of claim 29, wherein the encryption key is a Diffie-Hellman key exchange.

31. The apparatus of claim 29, wherein the security processing is Internet Key Exchange (IKE), Virtual Private Network, Internet Protocol Security (IPSec), Layer Two Tunneling Protocol (L2TP), Secure Sockets Layer (SSL) or Point-to-Point Tunneling Protocol (PPTP) packet processing.

32. The apparatus of claim 31, the processing of the outbound packet further comprising:
means for looking up a Security Association (SA) in an Incoming Security Association table to authenticate or encrypt the outbound packet.

33. The apparatus of 32, wherein the Incoming Security Association table includes a lookup key comprising the Internet Protocol Security in an authentication header.

34. The apparatus of 33, further comprising:
means for dropping the outbound packet if the look up fails.

35. The apparatus of 34, further comprising:
means for logging the dropped outbound packet if the lookup fails.

36. The apparatus of 35, further comprising:
means for authenticating data within the outbound packet if the look up succeeds.

37. The apparatus of 36, further comprising:
means for encrypting data within the outbound packet if the look up succeeds.
